(19) United States
(12) Patent Application Publication
(10) Pub. No.: US 2020/0327495 A1
(43) Pub. Date: Oct. 15, 2020

(54) DELIVERY SYSTEM, MANAGING SERVER, COMPUTER-READABLE STORAGE MEDIUM, AND MANAGEMENT METHOD

(71) Applicant: SoftBank Group Corp., Tokyo (JP)

(72) Inventor: Masayoshi Son, Tokyo (JP)

(21) Appl. No.: 16/596,766

(22) Filed: Oct. 9, 2019

(30) Foreign Application Priority Data
Apr. 11, 2019 (JP) 2019-075791

(51) Int. Cl. G06Q 10/08; G06Q 50/30

(52) U.S. Cl. CPC G06Q 10/08345; G06Q 50/30; G06Q 10/08355; G06Q 10/0832

(57) ABSTRACT

A delivery system is provided, the delivery system including: a superordinate vehicle that transports a plurality of packages and is capable of automated driving; a subordinate vehicle that transports a package received from the superordinate vehicle, and is capable of automated driving; and a managing server that manages automated delivery of a package by the superordinate vehicle and the subordinate vehicle, and manual delivery of a package by a courier, wherein the managing server has: a package information acquiring unit that acquires package information including at least any one of delivery destination information related to a delivery destination of a package, and content information related to a content of the package; and a delivery method selecting unit that selects a delivery method for the package from the automated delivery and the manual delivery based on the package information.

The contents of the following Japanese patent application are incorporated herein by reference: 2019-075791 filed in JP on Apr. 11, 2019

### BACKGROUND

### 1. Technical Field

The present invention relates to a delivery system, a managing server, a computer-readable storage medium, and a management method.

### 2. Related Art

There are known package managing systems to manage packages to be delivered (see Patent Literature 1, for example).

### PRIOR ART LITERATURE

### Patent Literature

[Patent Literature 1] Japanese Patent Application Publication No. 2014-189361

### SUMMARY

It is desirable to provide a technology that can appropriately manage delivery of packages.

### BRIEF DESCRIPTION OF THE DRAWINGS

FIG. 1 schematically illustrates an exemplary delivery system 10.

FIG. 2 schematically illustrates an exemplary flow of processing to be performed by a managing server 100.

FIG. 3 schematically illustrates another exemplary delivery system 10.

FIG. 4 schematically illustrates an exemplary flow of processing to be performed by the managing server 100.

FIG. 5 schematically illustrates an exemplary functional configuration of the managing server 100.

FIG. 6 schematically illustrates an exemplary hardware configuration of a computer 1200 to function as the managing server 100.

### DESCRIPTION OF EXEMPLARY EMBODIMENTS

Hereinafter, (some) embodiment(s) of the present invention will be described. The embodiment(s) do(es) not limit the invention according to the claims, and all the combinations of the features described in the embodiment(s) are not necessarily essential to means provided by aspects of the invention.

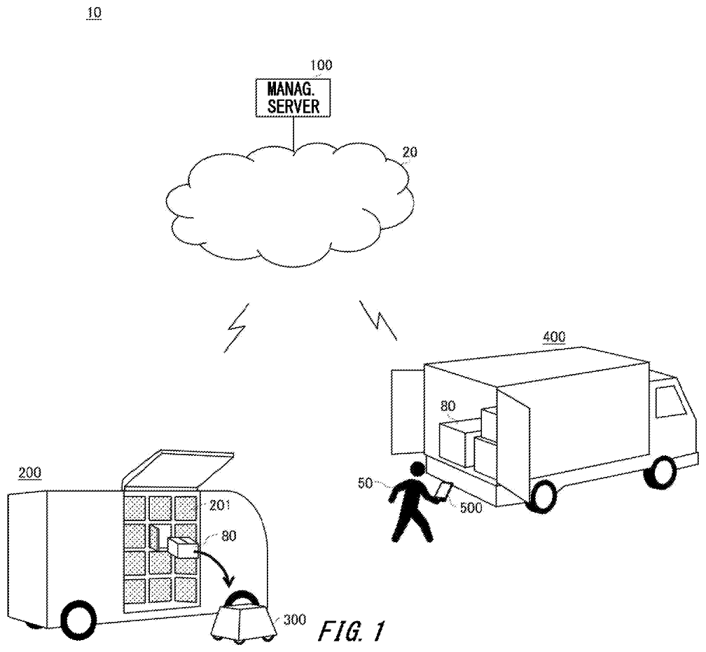

FIG. 1 schematically illustrates an exemplary delivery system 10. The delivery system 10 according to the present embodiment includes a superordinate vehicle 200, a subordinate vehicle 300, and a managing server 100.

The superordinate vehicle 200 can transport a plurality of packages 80. The superordinate vehicle 200 may be capable of automated driving. The subordinate vehicle 300 can transport at least one package 80. The subordinate vehicle 300 transports a package 80 received from the superordinate vehicle 200, for example. The subordinate vehicle 300 may be capable of automated driving. The number of subordinate vehicles 300 corresponding to the superordinate vehicle 200 may be one or larger than one.

The managing server 100 manages delivery of packages. The managing server 100 manages automated delivery of packages 80 by the superordinate vehicle 200 and subordinate vehicles 300. For example, the managing server 100 decides a delivery schedule for packages 80 loaded onto the superordinate vehicle 200, and sends a delivery instruction to the superordinate vehicle 200 based on the delivery schedule.

The managing server 100 and the superordinate vehicle 200 communicate with each other via a network 20. The network 20 may include a cellular communication network and the Internet. The cellular communication network may conform to any of the 3G (3rd Generation) communication standard, LTE (Long Term Evolution) communication standard, 5G (5th Generation) communication standard, or communication standards of and following the 6G (6th Generation) communication standard. The superordinate vehicle 200 may access a cellular communication network via a wireless base station, and may access a cellular communication network via a WiFi (registered trademark) connection.

The managing server 100 and a subordinate vehicle 300 may communicate with each other via the network 20 similar to communication between the managing server 100 and the superordinate vehicle 200. In addition, the managing server 100 and a subordinate vehicle 300 may communicate with each other via the superordinate vehicle 200. The superordinate vehicle 200 and a subordinate vehicle 300 may communicate with each other via the network 20. In addition, the superordinate vehicle 200 and a subordinate vehicle 300 may communicate with each other via a WiFi connection.

The superordinate vehicle 200 has a plurality of housing units 201 each of which can house a package 80, for example. The housing units 201 can house various types of packages 80.

The superordinate vehicle 200 may be loaded with packages 80 at any location. The superordinate vehicle 200 is loaded with packages 80 collected by a transport company, for example. In addition, the superordinate vehicle 200 is loaded with packages 80 at a so-called logistics center, for example. In addition, for example, the superordinate vehicle 200 travels to the position of a sender who is to send a package 80, and picks up and is loaded with the package 80. Loading of packages 80 to the superordinate vehicle 200 may be performed manually, and also may be performed by a machine such as a robot.

The management by the managing server 100 may start when packages 80 are picked up. For example, if the managing server 100 receives a pick-up request, the managing server 100 instructs the superordinate vehicle 200 to travel to a designated location, and to pick up a package 80. The package may be picked up by the superordinate vehicle 200 or by a subordinate vehicle 300. For example, for a plurality of pick-up requests given from a certain region, the managing server 100 makes the superordinate vehicle 200 travel to a location in or near the region. Then, the managing server 100 or superordinate vehicle 200 instructs a subordinate vehicle 300 to travel to a designated location, and to pick up a package 80. The subordinate vehicle 300 transports the package 80 that it has picked up to the superordinate vehicle 200, and passes it to the superordinate vehicle 200.

For example, the superordinate vehicle 200 is loaded with a plurality of packages 80 to be delivered to delivery destinations that are in a certain region, and transports the packages 80 to a certain location in or near the region. A subordinate vehicle 300 may travel to the region along with the superordinate vehicle 200. In addition, the subordinate vehicle 300 may travel to the region separately from the superordinate vehicle 200, and meet the superordinate vehicle 200.

The subordinate vehicle 300 receives a package 80 from the superordinate vehicle 200, and transports it to the delivery destination. Receipt of the package 80 by the subordinate vehicle 300 from the superordinate vehicle 200 may be performed by any method. For example, the package 80 in the superordinate vehicle 200 is passed to the subordinate vehicle 300 manually. In addition, for example, the package 80 is passed from the superordinate vehicle 200 to the subordinate vehicle 300 by a mechanical arm or the like provided to at least any one of the superordinate vehicle 200 and the subordinate vehicle 300.

Upon arriving at the delivery destination for example, the subordinate vehicle 300 notifies the recipient of the package 80 about the arrival. The subordinate vehicle 300 sends notification data to a smartphone or the like of the recipient of the package 80, for example. In addition, the subordinate vehicle 300 notifies the arrival by manipulating an intercom or the like installed at a delivery destination residence by a robot arm or the like, for example.

In addition, the managing server 100 manages manual delivery of packages 80 by a courier 50. Manual delivery of packages 80 by a courier 50 may mean that the packages 80 are transported in a delivery vehicle 400 driven by the courier 50, and the packages 80 are taken out of the delivery vehicle 400 to be delivered to delivery destinations, for example. For example, the managing server 100 decides a delivery schedule for packages 80 loaded onto the delivery vehicle 400, and sends a delivery instruction to a mobile communication terminal 500 carried by the courier 50 based on the delivery schedule.

The managing server 100 and the mobile communication terminal 500 communicate with each other via the network 20. The mobile communication terminal 500 may access a cellular communication network via a wireless base station, and may access a cellular communication network via a WiFi (registered trademark) connection.

The mobile communication terminal 500 may be a mobile terminal dedicated for delivery tasks. In addition, the mobile communication terminal 500 may be a mobile phone such as a smartphone, a tablet terminal, or the like.

The managing server 100 according to the present embodiment decides a delivery method for a package 80 based on package information including at least any one of delivery destination information related to the delivery destination of the package 80, and content information related to the content of the package 80. For example, the managing server 100 selects a delivery method from automated delivery by the superordinate vehicle 200 and a subordinate vehicle 300, and manual delivery by the delivery vehicle 400.

The managing server 100 selects manual delivery if the delivery destination of a package 80 is a multi-dwelling unit, and selects automated delivery if the delivery destination is a house, for example. If automated delivery is performed when the delivery destination is a multi-dwelling unit, a subordinate vehicle 300 can arrive at the entrance of the multi-dwelling unit, but cannot arrive at the entrance of a delivery destination residence in some cases. In such a case, for example, it becomes necessary to ask the recipient of the package 80 to come out to the entrance of the multi-dwelling unit to receive the package 80, and the convenience for the recipient inadvertently deteriorates significantly. According to the managing server 100, since manual delivery is selected if the delivery destination is a multi-dwelling unit, such deterioration of the convenience for the recipient can be prevented. In addition, according to the managing server 100, since automated delivery is selected if the delivery destination is a house, the load on the courier 50 can be reduced, and/or the delivery efficiency about the package 80 can be improved.

In addition, the managing server 100 selects automated delivery if the weight of a package 80 is heavier than a predetermined weight, for example. The predetermined weight may be set and altered arbitrarily. In addition, the managing server 100 selects manual delivery if the weight of a package 80 is lighter than a predetermined weight, for example. The predetermined weight may be set and altered arbitrarily. Thereby, the burden on the courier 50 can be reduced appropriately.

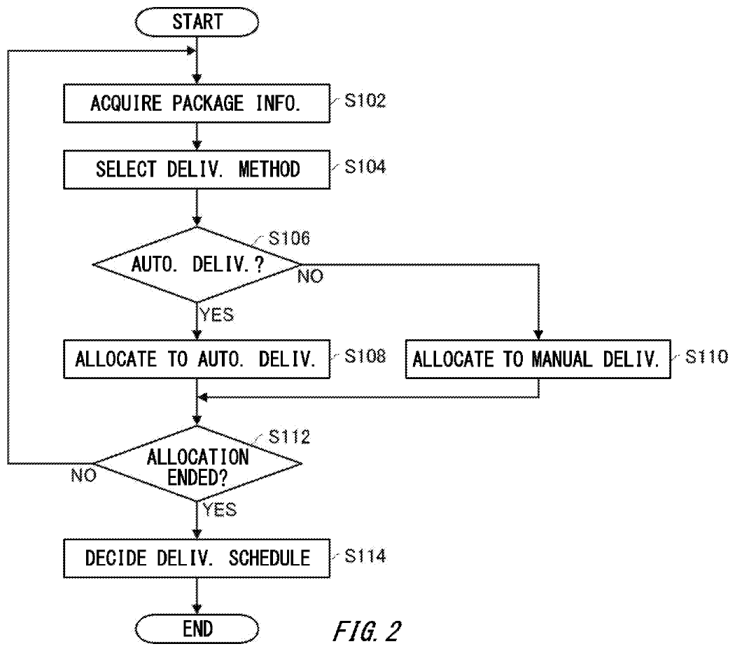

FIG. 2 schematically illustrates an exemplary flow of processing to be performed by the managing server 100. Here, a flow of processing performed by the managing server 100 to sequentially acquire information about delivery target packages 80, and decide a delivery schedule for a plurality of the packages 80 is schematically illustrated. Each process illustrated in FIG. 2 is executed under the control of the managing server 100.

At Step (steps are abbreviated to S's in some cases) 102, package information about a first delivery target package 80 is acquired. At S104, a delivery method for the package 80 is selected based on the package information acquired at S102. If automated delivery is selected (YES at S106), the process proceeds to S108, and if manual delivery is selected (NO at S106), the process proceeds to S110.

At S108, the package 80 is allocated to automated delivery. At S110, the package 80 is allocated to manual delivery. At S112, it is determined whether or not allocation has been ended for all the delivery target packages 80. If it is determined that the allocation has not been ended, the process returns to S102, and if it is determined that the allocation has been ended, the process proceeds to S114.

At S114, a delivery schedule for automated delivery, and a delivery schedule for manual delivery are decided. For each of a plurality of packages 80 allocated to automated delivery, the managing server 100 decides a delivery schedule including a superordinate vehicle 200 in which the package 80 is to be housed, a scheduled delivery time, a travel destination of the superordinate vehicle 200, a travel path of the superordinate vehicle 200, a travel destination of a subordinate vehicle 300, a travel path of the subordinate vehicle 300, and the like. In addition, for each of a plurality of packages 80 allocated to manual delivery, the managing server 100 decides a delivery schedule including a delivery vehicle 400 in which the package 80 is to be housed, a courier 50 to be in charge of the package 80, a scheduled delivery time, and the like.

According to the delivery schedules decided by the managing server 100 through the processes mentioned above, automated delivery and manual delivery of the packages 80 are executed.

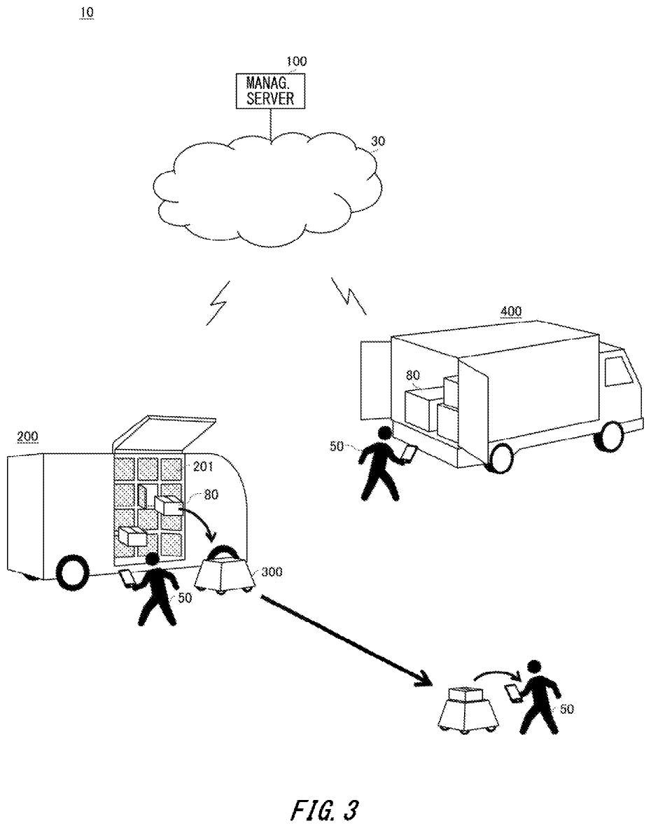

FIG. 3 schematically illustrates another exemplary delivery system 10. In addition to automated delivery by the superordinate vehicle 200 and a subordinate vehicle 300, and manual delivery by a courier 50, the managing server 100 in the delivery system 10 illustrated in FIG. 3 manages cooperative delivery achieved by cooperation between the automated transportation by the superordinate vehicle 200 and the subordinate vehicle 300, and manual transportation by the courier 50.

In the cooperative delivery, the superordinate vehicle 200 and the subordinate vehicle 300 transport a package 80 to a delivery destination-supporting geographical point corresponding to the delivery destination of the package 80, and the courier 50 carries the package 80 from the delivery destination-supporting geographical point to the delivery destination. The delivery destination-supporting geographical point may be decided arbitrarily. For example, the delivery destination-supporting geographical point selected is a geographical point which is near the delivery destination, and at which the package 80 can be passed over to and received by the courier 50 easily. The managing server 100 may decide the delivery destination-supporting geographical point based on delivery destination information related to the delivery destination of the package 80.

For example, the managing server 100 decides the delivery destination-supporting geographical point, and notifies the courier 50 of the delivery destination-supporting geographical point, and a time at which the package 80 arrives at the delivery destination-supporting geographical point. Then, the managing server 100 makes the package 80 transported to the delivery destination-supporting geographical point by automated delivery by the superordinate vehicle 200 and a subordinate vehicle 300. The courier 50 receives the package 80 at the delivery destination-supporting geographical point, and delivers it to the delivery destination.

The managing server 100 selects cooperative delivery if the delivery destination of the package 80 is a multi-dwelling unit, for example. For example, the managing server 100 decides, as the delivery destination-supporting geographical point, a location which is near the multi-dwelling unit, and at which the package 80 can be passed over to and received by the courier 50 easily, or the like. Then, the managing server 100 decides a delivery schedule such that the package 80 is transported to the delivery destination-supporting geographical point by the superordinate vehicle 200 and subordinate vehicle 300, and the package 80 is transported by the courier 50 from the delivery destination-supporting geographical point.

The courier 50 may be a full-time courier belonging to a delivery company, for example. In addition, the courier 50 may be a registered person pre-registered to operate as a courier temporarily, for example. The managing server 100 receives the registration from a mobile communication terminal of the registered person, for example. The mobile communication terminal of the registered person may be a mobile phone such as a smartphone, a tablet terminal, or the like. The registered person installs a dedicated application in the mobile communication terminal when he/she is to be registered in the managing server 100, for example. The managing server 100 acquires various types of information from the mobile communication terminal in cooperation with the application installed in the mobile communication terminal.

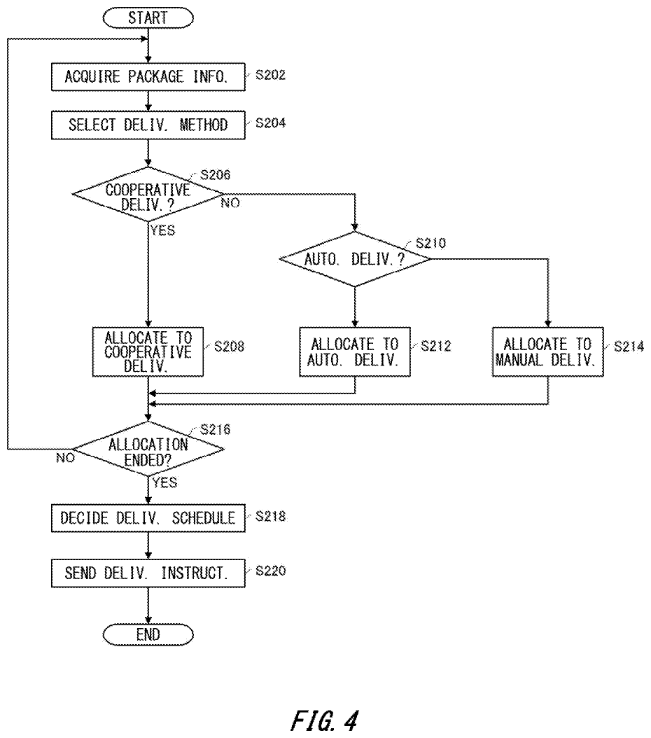

FIG. 4 schematically illustrates an exemplary flow of processing to be performed by the managing server 100. Here, differences from FIG. 2 are mainly explained.

At S202, package information about a first delivery target package 80 is acquired. At S204, a delivery method for the package 80 is selected based on the package information acquired at S202. If cooperative delivery is selected (YES at S206), the process proceeds to S208. If automated delivery is selected at S210 (YES at S210), the process proceeds to S212, and if manual delivery is selected (NO at S210), the process proceeds to S214.

At S208, the package 80 is allocated to cooperative delivery. At S212, the package 80 is allocated to automated delivery. At S214, the package 80 is allocated to manual delivery. At S216, it is determined whether or not allocation has been ended for all the delivery target packages 80. If it is determined that the allocation has not been ended, the process returns to S202, and if it is determined that the allocation has been ended, the process proceeds to S218.

At S218, a delivery schedule for cooperative delivery, a delivery schedule for automated delivery, and a delivery schedule for manual delivery are decided. For each of a plurality of packages 80 allocated to cooperative delivery, the managing server 100 decides a delivery schedule including a superordinate vehicle 200 in which the package 80 is to be housed, a delivery-supporting geographical point, a scheduled delivery time, a travel destination of the superordinate vehicle 200, a travel path of the superordinate vehicle 200, a travel destination of a subordinate vehicle 300, a travel path of the subordinate vehicle 300, a travel destination of a courier 50, a travel path of the courier 50, and the like.

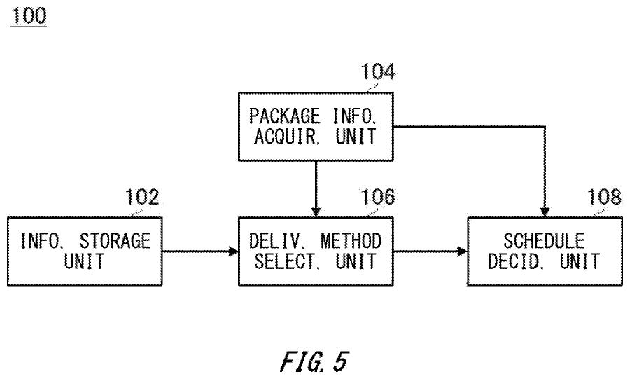

FIG. 5 schematically illustrates an exemplary functional configuration of the managing server 100. The managing server 100 includes an information storage unit 102, a package information acquiring unit 104, a delivery method selecting unit 106, and a schedule deciding unit 108.

The information storage unit 102 stores various types of information. The information storage unit 102 stores map information, for example. The map information may include information about the types of buildings at each location. The map information may include geographical-feature information related to the geographical feature of each location. The information storage unit 102 may store reception intensity information indicating the reception intensity of radio wave at each location from a wireless base station in a cellular communication system arranged at the location.

The package information acquiring unit 104 acquires package information about delivery target packages 80. The package information acquiring unit 104 acquires package information designated by the sender of a package 80, for example. For example, the sender of the package 80 may fill out a delivery slip with package information, and/or input package information as electronic data into the managing server 100 to designate the package information. As mentioned above, the package information includes at least any one of delivery destination information related to the delivery destination of the package 80 and content information related to the content of the package 80.

The content information may include weight information indicating the weight of the package 80. The weight information may be information indicating the weight with a numerical value in grams, kilograms, or the like. In addition, the weight information may be information indicating weight-based classification such as heavy, normal, or light.

In addition, the content information may include price information indicating the price of the package 80. The price information may be information indicating the monetary value of the package 80 with a numerical value. In addition, the price information may be information indicating price-based classification such as high, normal, or low.

In addition, the content information may include size information indicating the size of the package 80. The size information may be information indicating the dimension of the package 80 with a numerical value. In addition, the size information may be information indicating size-based classification such as large, normal, or small.

The delivery method selecting unit 106 decides a delivery method for the package 80 based on the package information acquired by the package information acquiring unit 104. For example, the delivery method selecting unit 106 selects the delivery method for the package 80 from automated delivery by the superordinate vehicle 200 and a subordinate vehicle 300, and manual delivery by a courier 50.

The delivery method selecting unit 106 may select the delivery destination based on information about a delivery destination residence. For example, the delivery method selecting unit 106 may identify the type of the delivery destination residence based on the delivery destination address. In addition, for example, the delivery method selecting unit 106 may refer to the map information stored in the information storage unit 102 to identify the type of a residence corresponding to the delivery destination address.

For example, the delivery method selecting unit 106 selects automated delivery if the delivery destination is a house. In addition, for example, the delivery method selecting unit 106 selects manual delivery if the delivery destination is a multi-dwelling unit.

The delivery method selecting unit 106 may select the delivery method based on geographical-feature information about an area that is within a predetermined range from the delivery destination. For example, the delivery method selecting unit 106 acquires geographical-feature information about an area that is within a predetermined range from the delivery destination, from the map information stored in the information storage unit 102.

For example, the delivery method selecting unit 106 determines whether or not it is possible for a subordinate vehicle 300 to arrive at the delivery destination based on the geographical-feature information. The delivery method selecting unit 106 selects automated delivery if it is determined that it is possible, and selects manual delivery if it is determined that it is not possible.

The delivery method selecting unit 106 may select the delivery method based on the reception intensity information stored in the information storage unit 102. For example, the delivery method selecting unit 106 selects manual delivery if there is a geographical point in a schedule travel path of a subordinate vehicle 300 where the reception intensity of radio wave is lower than a predetermined intensity, and selects automated delivery if there is not such a geographical point.

The delivery method selecting unit 106 may select the delivery method based on the weight information of the package 80 included in the package information acquired by the package information acquiring unit 104. For example, the delivery method selecting unit 106 selects automated delivery if the weight of the package 80 is heavier than a predetermined weight. In addition, for example, the delivery method selecting unit 106 selects manual delivery if the weight of the package 80 is lighter than the predetermined weight.

The delivery method selecting unit 106 may select the delivery method based on the price information of the package 80 included in the package information acquired by the package information acquiring unit 104. For example, the delivery method selecting unit 106 selects manual delivery if the price indicated by the price information is higher than a predetermined price. In addition, for example, the delivery method selecting unit 106 selects automated delivery if the price indicated by the price information is lower than the predetermined price.

The delivery method selecting unit 106 may select the delivery method based on the size information of the package 80 included in the package information acquired by the package information acquiring unit 104. For example, the delivery method selecting unit 106 selects automated delivery if the size indicated by the size information is larger than a predetermined size. In addition, for example, the delivery method selecting unit 106 selects manual delivery if the size of the package 80 is smaller than the predetermined size.

The delivery method selecting unit 106 may select the delivery method based on a plurality of types of information among the weight information, price information and size information of the package 80 that are included in the package information. For example, if the weight indicated by the weight information is lighter than the predetermined weight, the delivery method selecting unit 106 selects automated delivery provided that the size indicated by the size information is larger than the predetermined size, and selects manual delivery provided that the size is smaller than the predetermined size. If the weight indicated by the weight information is heavier than the predetermined weight, the delivery method selecting unit 106 may select automated delivery regardless of the size information. In addition, if the weight indicated by the weight information is heavier than the predetermined weight, the delivery method selecting unit 106 may select automated delivery provided that the size indicated by the size information is larger than the predetermined size, and may select manual delivery provided that the size is smaller than the predetermined size.

In addition, for example, if the weight indicated by the weight information is lighter than the predetermined weight, the delivery method selecting unit 106 selects manual delivery provided that the price indicated by the price information is higher than the predetermined price, and selects automated delivery if the price is lower than the predetermined price. If the weight indicated by the weight information is heavier than the predetermined weight, the delivery method selecting unit 106 may select automated delivery regardless of the price information. In addition, if the weight indicated by the weight information is heavier than the predetermined weight, the delivery method selecting unit 106 may select manual delivery provided that the price indicated by the price information is higher than the predetermined price, and may select automated delivery if the price is lower than the predetermined price.

In addition, for example, if the size indicated by the size information is smaller than the predetermined size, the delivery method selecting unit 106 selects manual delivery provided that the price indicated by the price information is higher than the predetermined price, and selects automated delivery if the price is lower than the predetermined price. If the size indicated by the size information is larger than the predetermined size, the delivery method selecting unit 106 may select automated delivery regardless of the price information. In addition, if the size indicated by the size information is larger than the predetermined size, the delivery method selecting unit 106 may select manual delivery provided that the price indicated by the price information is higher than the predetermined price, and may select automated delivery if the price is lower than the predetermined price.

In addition, for example, the delivery method selecting unit 106 selects, as the delivery method for the package 80, from automated delivery by the superordinate vehicle 200 and a subordinate vehicle 300, and manual delivery by a courier 50, and cooperative delivery achieved by cooperation between the automated transportation by the superordinate vehicle 200 and the subordinate vehicle 300, and manual transportation by the courier 50.

The delivery method selecting unit 106 may select the delivery method based on the type of a delivery destination residence. For example, the delivery method selecting unit 106 selects automated delivery if the delivery destination is a house, and selects manual delivery or cooperative delivery if the delivery destination is a multi-dwelling unit.

The schedule deciding unit 108 decides a delivery schedule for the package 80 based on the delivery method selected by the delivery method selecting unit 106. The schedule deciding unit 108 decides a delivery schedule for automated delivery, for example. For each of a plurality of packages 80 allocated to automated delivery, the schedule deciding unit 108 may decide a delivery schedule including a superordinate vehicle 200 in which the package 80 is to be housed, a scheduled delivery time, a travel destination of the superordinate vehicle 200, a travel path of the superordinate vehicle 200, a travel destination of a subordinate vehicle 300, a travel path of the subordinate vehicle 300, and the like.

The schedule deciding unit 108 decides a delivery schedule for manual delivery, for example. For each of a plurality of packages 80 allocated to manual delivery, the schedule deciding unit 108 may decide a delivery schedule including a delivery vehicle 400 in which the package 80 is to be housed, a courier 50 to be in charge of the package 80, a scheduled delivery time, and the like.

The schedule deciding unit 108 decides a delivery schedule for cooperative delivery, for example. For each of a plurality of packages 80 allocated to cooperative delivery, the schedule deciding unit 108 decides a delivery schedule including a superordinate vehicle 200 in which the package 80 is to be housed, a delivery-supporting geographical point, a scheduled delivery time, a travel destination of the superordinate vehicle 200, a travel path of the superordinate vehicle 200, a travel destination of a subordinate vehicle 300, a travel path of the subordinate vehicle 300, a travel destination of a courier 50, a travel path of the courier 50, and the like.

For example, if the delivery destination is a multi-dwelling unit, and cooperative delivery is selected, the schedule deciding unit 108 may decide a delivery schedule such that the package 80 is transported to a supporting position corresponding to the multi-dwelling unit by the superordinate vehicle 200 and a subordinate vehicle 300, and the package is transported by a courier from the supporting position.

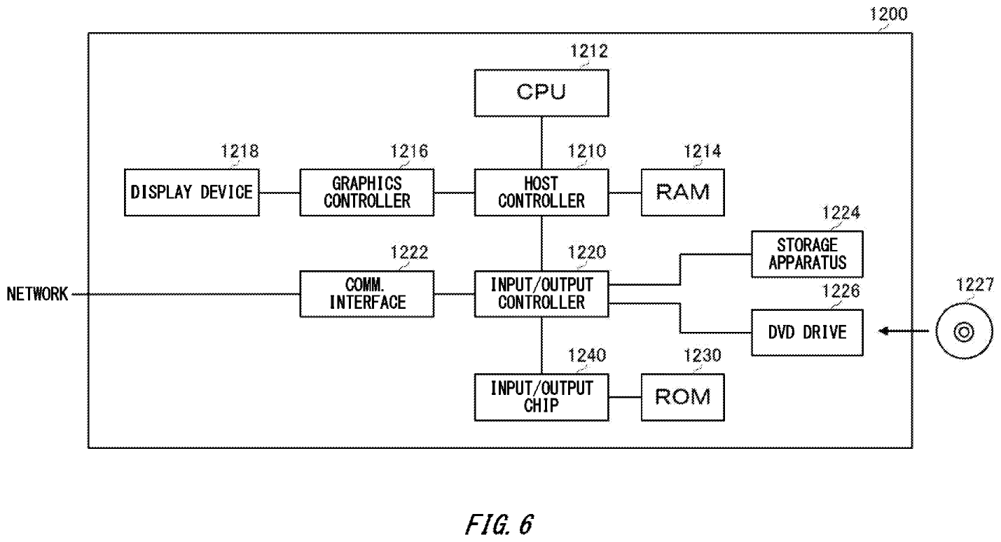

FIG. 6 schematically illustrates an exemplary hardware configuration of a computer 1200 to function as the managing server 100. A program that is installed in the computer 1200 can cause the computer 1200 to function as or perform operations associated with apparatuses of the embodiments of the present invention or one or more sections thereof, and/or cause the computer 1200 to perform processes of the embodiments of the present invention or steps thereof. Such a program may be executed by the CPU 1212 to cause the computer 1200 to perform certain operations associated with some or all of the blocks of flowcharts and block diagrams described herein.

The computer 1200 according to the present embodiment includes a CPU 1212, a RAM 1214, and a graphics controller 1216, which are mutually connected by a host controller 1210. The computer 1200 also includes input/output units such as a communication interface 1222, a storage apparatus 1224, a DVD drive 1226 and an IC card drive, which are connected to the host controller 1210 via an input/output controller 1220. The DVD drive 1226 may be a DVD-ROM drive, a DVD-RAM drive, or the like. The storage apparatus 1224 may be a hard disk drive, a solid state drive, or the like. The computer 1200 also includes legacy input/output units such as a ROM 1230 and a keyboard, which are connected to the input/output controller 1220 through an input/output chip 1240.

The CPU 1212 operates according to programs stored in the ROM 1230 and the RAM 1214, thereby controlling each unit. The graphics controller 1216 obtains image data generated by the CPU 1212 on a frame buffer or the like provided in the RAM 1214 or in itself, and causes the image data to be displayed on the display device 1218.

The communication interface 1222 communicates with other electronic devices via a network. The storage apparatus 1224 stores programs and data used by the CPU 1212 within the computer 1200. The DVD drive 1226 reads the programs or the data from the DVD-ROM 1227, and the like, and provides the storage apparatus 1224 with the programs or the data. The IC card drive reads programs and data from an IC card, and/or writes programs and data into the IC card.

The ROM 1230 stores therein a boot program or the like executed by the computer 1200 at the time of activation, and/or a program depending on the hardware of the computer 1200. The input/output chip 1240 may also connect various input/output units via a USB port, a parallel port, a serial port, a keyboard port, a mouse port, and the like to the input/output controller 1220.

A program is provided by computer-readable storage media such as the DVD-ROM 1227 or the IC card. The program is read from the computer-readable storage media, installed into the storage apparatus 1224, RAM 1214, or ROM 1230, which are also examples of computer-readable storage media, and executed by the CPU 1212. The information processing described in these programs is read into the computer 1200, resulting in cooperation between a program and the above-mentioned various types of hardware resources. An apparatus or method may be constituted by realizing the operation or processing of information in accordance with the usage of the computer 1200.

For example, when communication is performed between the computer 1200 and an external device, the CPU 1212 may execute a communication program loaded onto the RAM 1214 to instruct communication processing to the communication interface 1222, based on the processing described in the communication program. The communication interface 1222, under control of the CPU 1212, reads transmission data stored on a transmission buffering region provided in a recording medium such as the RAM 1214, the storage apparatus 1224, the DVD-ROM 1227, or the IC card, and transmits the read transmission data to a network or writes reception data received from a network to a reception buffering region or the like provided on the recording medium.

In addition, the CPU 1212 may cause all or a necessary portion of a file or a database to be read into the RAM 1214, the file or the database having been stored in an external recording medium such as the storage apparatus 1224, the DVD drive 1226 (DVD-ROM 1227), the IC card, etc., and perform various types of processing on the data on the RAM 1214. The CPU 1212 may then write back the processed data to the external recording medium.

Various types of information, such as various types of programs, data, tables, and databases, may be stored in the recording medium to undergo information processing. The CPU 1212 may perform various types of processing on the data read from the RAM 1214, which includes various types of operations, processing of information, condition judging, conditional branch, unconditional branch, search/replace of information, etc., as described throughout this disclosure and designated by an instruction sequence of programs, and writes the result back to the RAM 1214. In addition, the CPU 1212 may search for information in a file, a database, etc., in the recording medium. For example, when a plurality of entries, each having an attribute value of a first attribute associated with an attribute value of a second attribute, are stored in the recording medium, the CPU 1212 may search for an entry matching the condition whose attribute value of the first attribute is designated, from among the plurality of entries, and read the attribute value of the second attribute stored in the entry, thereby obtaining the attribute value of the second attribute associated with the first attribute satisfying the predetermined condition.

The above-explained program or software modules may be stored in the computer-readable storage media on or near the computer 1200. In addition, a recording medium such as a hard disk or a RAM provided in a server system connected to a dedicated communication network or the Internet can be used as the computer-readable storage media, thereby providing the program to the computer 1200 via the network.

Various embodiments of the present invention may be described with reference to flowcharts and block diagrams whose blocks may represent (1) steps of processes in which operations are performed or (2) sections of apparatuses responsible for performing operations. Certain steps and sections may be implemented by dedicated circuitry, programmable circuitry supplied with computer-readable instructions stored on computer-readable storage media, and/or processors supplied with computer-readable instructions stored on computer-readable storage media. Dedicated circuitry may include digital and/or analog hardware circuits and may include integrated circuits (IC) and/or discrete circuits. Programmable circuitry may include reconfigurable hardware circuits comprising logical AND, OR, XOR, NAND, NOR, and other logical operations, flip-flops, registers, memory elements, etc., such as field-programmable gate arrays (FPGA), programmable logic arrays (PLA), etc.

Computer-readable storage media may include any tangible device that can store instructions for execution by a suitable device, such that the computer-readable medium having instructions stored therein comprises an article of manufacture including instructions which can be executed to create means for performing operations specified in the flowcharts or block diagrams. Examples of computer-readable storage media may include an electronic storage medium, a magnetic storage medium, an optical storage medium, an electromagnetic storage medium, a semiconductor storage medium, etc. More specific examples of computer-readable storage media may include a floppy (registered trademark) disk, a diskette, a hard disk, a random access memory (RAM), a read-only memory (ROM), an erasable programmable read-only memory (EPROM or Flash memory), an electrically erasable programmable read-only memory (EEPROM), a static random access memory (SRAM), a compact disc read-only memory (CD-ROM), a digital versatile disk (DVD), a BLU-RAY (registered trademark) disc, a memory stick, an integrated circuit card, etc.

Computer-readable instructions may include assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, JAVA (registered trademark), C++, etc., and conventional procedural programming languages, such as the “C” programming language or similar programming languages.

Computer-readable instructions may be provided to a processor of a general purpose computer, special purpose computer, or other programmable data processing apparatus, or to programmable circuitry, locally or via a local area network (LAN), wide area network (WAN) such as the Internet, etc., to execute the computer-readable instructions to create means for performing operations specified in the flowcharts or block diagrams. Examples of processors include computer processors, processing units, microprocessors, digital signal processors, controllers, microcontrollers, etc.

While the embodiments of the present invention have been described, the technical scope of the invention is not limited to the above described embodiments. It is apparent to persons skilled in the art that various alterations and improvements can be added to the above-described embodiments. It is also apparent from the scope of the claims that the embodiments added with such alterations or improvements can be included in the technical scope of the invention.

The operations, procedures, steps, and stages of each process performed by an apparatus, system, program, and method shown in the claims, embodiments, or diagrams can be performed in any order as long as the order is not indicated by “prior to,” “before,” or the like and as long as the output from a previous process is not used in a later process. Even if the process flow is described using phrases such as “first” or “next” in the claims, embodiments, or diagrams, it does not necessarily mean that the process must be performed in this order.

### EXPLANATION OF REFERENCE SYMBOLS

10: delivery system; 20: network; 50: courier; 80: package; 100: managing server; 102: information storage unit; 104: package information acquiring unit; 106: delivery method selecting unit; 108: schedule deciding unit; 200: superordinate vehicle; 201: housing unit; 300: subordinate vehicle; 400: delivery vehicle; 500: mobile communication terminal; 1200: computer; 1210: host controller; 1212: CPU; 1214: RAM; 1216: graphics controller; 1218: display device; 1220: input/output controller; 1222: communication interface; 1224: storage apparatus; 1226: DVD drive; 1227: DVD-ROM; 1230: ROM; 1240: input/output chip

What is claimed is:

1. A delivery system comprising:
a superordinate vehicle that transports a plurality of packages and is capable of automated driving;
a subordinate vehicle that transports a package received from the superordinate vehicle, and is capable of automated driving; and
a managing server that manages automated delivery of a package by the superordinate vehicle and the subordinate vehicle, and manual delivery of a package by a courier, wherein
the managing server has:
a package information acquiring unit that acquires package information including at least any one of delivery destination information related to a delivery destination of a package, and content information related to a content of the package; and
a delivery method selecting unit that selects a delivery method for the package from the automated delivery and the manual delivery based on the package information.

2. The delivery system according to claim 1, wherein the delivery method selecting unit selects the delivery method based on a type of a residence of the delivery destination.

3. The delivery system according to claim 2, wherein the delivery method selecting unit selects the automated delivery if the delivery destination is a house, and selects the manual delivery if the delivery destination is a multi-dwelling unit.

4. The delivery system according to claim 1, wherein the delivery method selecting unit selects the delivery method based on geographical-feature information related to a geographical feature of an area that is within a predetermined range from the delivery destination.

5. The delivery system according to claim 4, wherein the delivery method selecting unit determines whether or not the subordinate vehicle can arrive at the delivery destination based on the geographical-feature information, and selects the automated delivery if it is determined that the subordinate vehicle can arrive, and selects the manual delivery if it is determined that the subordinate vehicle cannot arrive.

6. The delivery system according to claim 1, wherein
the superordinate vehicle and the subordinate vehicle communicate with the managing server via a wireless base station, and
the delivery method selecting unit selects the delivery method based on reception intensity information indicating a reception intensity of radio wave at each location in a region including the delivery destination, the radio wave being emitted from a wireless base station arranged in the region.

7. The delivery system according to claim 6, wherein the delivery method selecting unit selects the manual delivery if a schedule travel path of the subordinate vehicle includes a geographical point at which the reception intensity of radio wave is lower than a predetermined intensity, and otherwise selects the automated delivery.

8. The delivery system according to claim 1, wherein
the content information includes weight information related to a weight of the package, and
the delivery method selecting unit selects the delivery method based on the weight information.

9. The delivery system according to claim 8, wherein the delivery method selecting unit selects the automated delivery if the weight of the package is heavier than a predetermined weight, and selects the manual delivery if the weight of the package is lighter than a predetermined weight.

10. The delivery system according to claim 1, wherein
the content information includes price information related to a price of the package, and
the delivery method selecting unit selects the delivery method based on the price information.

11. The delivery system according to claim 1, wherein, based on at least any one of the delivery destination information and the content information, the delivery method selecting unit selects the delivery method for the package from the automated delivery, the manual delivery, and cooperative delivery achieved by cooperation between automated transportation by the superordinate vehicle and the subordinate vehicle and manual transportation by the courier.

12. The delivery system according to claim 11, wherein the delivery method selecting unit selects cooperative delivery as the delivery method if the delivery destination is a multi-dwelling unit.

13. The delivery system according to claim 12, wherein
the managing server has a schedule deciding unit that decides a delivery schedule for the package based on the delivery method selected by the delivery method selecting unit, and
if the delivery destination is a multi-dwelling unit, and the cooperative delivery is selected, the schedule deciding unit decides the delivery schedule to make the superordinate vehicle and the subordinate vehicle transport the package to a supporting position corresponding to the multi-dwelling unit, and make the courier transport the package from the supporting position.

14. The delivery system according to claim 1, wherein types of the courier include a full-time courier and a pre-registered registered person who operates as a courier temporarily.

15. A managing server comprising:
a package information acquiring unit that acquires package information including at least any one of delivery destination information related to a delivery destination of a package, and content information related to a content of the package; and
a delivery method selecting unit that selects a delivery method for the package from automated delivery by a vehicle capable of automated driving and manual delivery by a courier based on the package information.

16. The managing server according to claim 15, wherein the delivery method selecting unit selects the delivery method for the package from the manual delivery by the courier and the automated delivery by a superordinate vehicle that transports a plurality of packages, and is capable of automated driving and a subordinate vehicle that transports a package received from the superordinate vehicle, and is capable of automated driving.

17. A non-transitory computer-readable storage medium having stored thereon a program for making a computer function as:
a package information acquiring unit that acquires package information including at least any one of delivery destination information related to a delivery destination of a package, and content information related to a content of the package; and
a delivery method selecting unit that selects a delivery method for the package from automated delivery by a vehicle capable of automated driving and manual delivery by a courier based on the package information.

18. A management method executed by a computer, the management method comprising:
acquiring package information including delivery destination information related to a delivery destination of a package, and content information related to a content of the package; and
selecting a delivery method for the package from automated delivery by a vehicle capable of automated driving and manual delivery by a courier based on at least any one of the delivery destination information and the content information.
